(19) United States
(12) Patent Application Publication
(10) Pub. No.: US 2024/0017981 A1
(43) Pub. Date: Jan. 18, 2024

(54) Water dispenser and method for operating same

(71) Applicant: BWT Holding GmbH, Mondsee (AT)

(72) Inventors: Jürgen JOHANN, Mondsee (AT); Marcus DEPAUL, Schörfling (AT)

(73) Assignee: BWT Holding GmbH, Mondsee (AT)

(21) Appl. No.: 18/030,524

(22) PCT Filed: Oct. 8, 2021
(86) PCT No.: PCT/EP2021/077860

§ 371 Date: Apr. 6, 2023

(30) Foreign Application Priority Data
Oct. 8, 2020 (DE) 10 2020 126 392.9

(51) Int. Cl. B67D 1/00; B67D 1/08; B01F 23/236

(52) U.S. Cl. CPC B67D 1/0014; B67D 1/0895; B01F 23/2362; B67D 2210/00102

(57) ABSTRACT

The disclosure relates to a water dispenser comprising a preferably cooled carbonator for dispensing carbonated water. The water dispenser comprises a thermoblock, in particular a boiler, for dispensing warm water. The carbonator is connectible to a pressurized CO2 gas container. The water dispenser comprises at least one dosing valve, in particular a switching valve, through which carbon dioxide can be fed into the thermoblock.

### CROSS-REFERENCE TO RELATED APPLICATION

This application is a national stage application, filed under 35 U.S.C. § 371, of International Patent Application No. PCT/EP2021/077860, filed on 8 Oct. 2021, which claims the benefit of German Patent Application No. 10 2020 126 392.9, filed 8 Oct. 2020.

### TECHNICAL FIELD

The disclosure relates to a water dispenser which is configured to dispense carbonated water or carbonated beverages. The disclosure furthermore relates to a method for operating a water dispenser.

### BACKGROUND

Water dispensers and beverage making machines can comprise a cooled carbonator through which carbonated water can be dispensed. The carbonator comprises a cooled pressure vessel that is connected to a pressurized gas cylinder filled with carbon dioxide.

On the other hand, for dispensing hot water, for example for tea or for the preparation of hot beverages by the water dispenser itself, such a water dispenser can also comprise a boiler or flow heater, also known as a thermoblock, which is operable to provide hot water or hot beverages.

Especially in the boiler and the downstream pipe sections and components of the water dispenser, there is an increased buildup of so-called scale. This includes primarily calcium and magnesium carbonates.

In particular calcium salts contribute to the overall hardness of the water and thus to the formation of deposits. When the water in the boiler is heated, carbon dioxide will escape and the dissolved calcium bicarbonate will convert into insoluble calcium carbonate which forms limescale.

It has therefore long been known to reduce the total hardness of the water.

For example, a softening system can be used in a plumbing or installation system, which exchanges calcium and magnesium for sodium via an ion exchanger, thus reducing the degree of hardness of the water.

However, this can lead to a bad taste of the water, and excessive sodium is also unhealthy for the human organism.

For water dispensers, and especially for water dispensers in the form of beverage machines, there are therefore systems which soften the water using an ion exchanger that is loaded with hydrogen ions.

Such a system is marketed, for example, by the Applicant under the trade name “BestMax®”.

However, excessive softening of the water is undesirable. It has also been found that enriching the water with minerals other than calcium both improves the taste of the water and provides the user with physiologically important minerals.

A method for enriching the water with magnesium ions is known from patent document EP 2 094 611 B1 (BWT AG).

EP 3 507 247 B1 discloses a method and a device for enriching water with zinc ions.

For example, if an ion exchanger is used which contains magnesium ions, magnesium carbonates will still form in the boiler. Furthermore, in order to avoid scale in the boiler it is necessary to remove calcium to a sufficiently high degree, which in turn would not be necessary or is even undesirable for the cold water section of the water dispenser, since calcium also constitutes a physiologically important mineral.

Thus, inevitably, a large part of the capacity of the ion exchanger for hydrogen is virtually lost.

### SUMMARY

An object of the invention is to mitigate the drawbacks of the prior art mentioned above.

More particularly it is an object of the invention to reduce the formation of scale in the boiler of a beverage machine without removing magnesium from the water and/or without removing most of the calcium.

The object of the invention is already achieved by a water dispenser and by a method for operating a water dispenser according to any of the independent claim(s).

Preferred embodiments and refinements of the invention will be apparent from the subject-matter of the dependent claims, the description, and the drawings.

The disclosure relates to a water dispenser. The term “water dispenser” does not only refer to a machine for producing beverages, which dispenses water without further additives.

Rather, the disclosure also relates to water dispensers in the broadest sense.

This can encompass a water tap that is connected to an on-site water pipe.

Furthermore, the disclosure relates to water dispensers with or without a tank, which dispense hot and cold water.

The disclosure also relates to machines that use the water to produce hot beverages, e.g. tea or coffee, and/or which are operable to produce so-called soft drinks, i.e. carbonated sweetened beverages.

It will be appreciated that the main component of any such beverage is water.

The water dispenser comprises a heater. The heater is preferably powered electrically. In the case of water dispensers and machines for preparing beverages, such a heater is also referred to as a thermoblock.

The latter may be in the form of a boiler or a flow heater.

Furthermore, the heater may be in the form of a stationary water heater, in particular a wall and/or under-sink device.

It is intended that the water dispenser comprises at least one metering or dosing valve through which carbon dioxide can be fed into the heater.

The thermoblock may in particular be in the form of a boiler. According to a further embodiment, an implementation in the form of a flow heater is also conceivable.

The disclosure is based on the finding that the carbon dioxide can be exploited to increase the carbon dioxide content and hence the concentration of carbonic acid inside the boiler.

This lowers the pH value, thereby counteracting the previously described effect of scale formation due to the reduction of carbonic acid as caused by the heating.

According to a preferred embodiment, the water dispenser comprises a carbonator for dispensing carbonated water.

The carbonator is in particular in the form of a cooled pressure vessel.

The carbonator can be connected to a pressurized CO₂ gas container. From the pressurized gas container, carbon dioxide is fed to the carbonator, optionally via a pressure reducer.

Part of the carbon dioxide will dissolve in the water provided inside the carbonator, part of the carbon dioxide will form carbonic acid which lowers the pH of the water.

Such water dispensers are often configured for dispensing both chilled carbonated water and chilled non-carbonated water.

Water that is not desired to be enriched with carbonic acid can be merely directed along the cooling coils of the carbonator to the outlet.

The pressurized gas container employed for the carbonator can also be used to feed carbon dioxide to the heater.

According to one embodiment, the carbon dioxide from the pressurized gas container is in particular fed via a pressure reducer and introduced into the heater in gaseous form.

According to another embodiment, the carbon dioxide is introduced into the heater dissolved in water (together with dissociated dissolved carbonic acid). This can allow for easier dosing using a single dosing valve.

The dosing valve is preferably in the form of a switching valve.

More particularly, the dosing valve is in the form of a solenoid valve which can be opened by a controller.

The water dispenser therefore preferably comprises a controller which controls the introduction of carbon dioxide via the dosing valve.

In one embodiment, this control is executed on a volume basis and/or on a time basis. The controller temporarily opens the switching valve as a function of the volume passed through the boiler and/or as a function of time, in order to achieve the desired enrichment with carbon dioxide in the boiler.

Preferably, both the elapsed time and the volume of water that has flowed through the boiler are taken into account for calculating the opening times for the switching valve.

This implementation allows for particularly simple controlling. For example, no separate water meter is required to measure the flow rate through the boiler, rather, it can be determined indirectly via the number of hot beverages withdrawn.

Since the calcite separation capacity of the water gradually decreases as a result of the formation of carbon dioxide when heated, it can be useful to additionally supply carbon dioxide on a time basis.

Furthermore, according to one embodiment, the carbon dioxide can be dosed as a function of the heating of the thermoblock.

A boiler is temperature-controlled, i.e. when the machine is in stand-by mode, the boiler is heated in order to allow for withdrawal of a hot beverage.

For this purpose, the controller clocks and thus counteracts cooling. When a hot beverage is withdrawn, the water in the boiler will cool down due to inflowing water, and the boiler has to be controlled to heat more.

This can be exploited for controlling the introduction of carbon dioxide.

The same principle can also be applied to flow heaters, i.e. which only heat the water while it flows through the heater. The control mode is preferably adjustable to vary the amount of carbon dioxide as a function of elapsed time unit and/or on a volume basis.

The setting is preferably based on the degree of hardness of the input water.

In this embodiment, the water dispenser comprises setting means, such as a rotary knob or a display, which can be used to enter the degree of hardness of the water at the respective installation site.

On this basis, an electronic controller calculates how much carbon dioxide is required and then adjusts the release of CO₂ into the thermoblock.

According to one embodiment, the water dispenser comprises two switching valves arranged in series, which can be controlled alternately. The switching valves are in particular in the form of solenoid valves.

Such a pair of switching valves allows in a very simple manner to supply a small amount of carbon dioxide to the thermoblock.

As soon as the switching valve on the inlet side opens, i.e. the one immediately downstream of the pressurized CO₂ container, an intermediate section located between the switching valves will be pressurized.

In this way, a pressure-dependent amount of CO₂ will be introduced into this line section, and when the switching valve on the output side opens, a small amount of carbon dioxide will be introduced, depending on the volume of the line section and as a function of the pressure in the thermoblock and the carbon dioxide pressure applied.

Thus, the pressurized gas container and the two switching valves form a dosing pump of very simple configuration.

The disclosure also relates to an assembly comprising the water dispenser as described above.

The assembly furthermore comprises a cartridge for water treatment, through which water is supplied to the water dispenser.

Mostly, as in the aforementioned system, for example, such cartridges are cartridges that are installed inline in a filter cartridge head. The filter cartridge head is usually located outside of the water dispenser. However, it is also possible for the cartridge to be integrated in the water dispenser.

The cartridge may in particular be configured for releasing a mineral into the water, in particular magnesium, silicon, lithium, and/or zinc.

Due to the implementation according to the disclosure, only a small amount of scale will form, despite the presence of magnesium in the water which is fed into the boiler.

The ion exchange material can be loaded with magnesium or zinc to a degree of at least 30%, preferably at least 50% of its total capacity.

The ion exchange material is preferably loaded with hydrogen and/or sodium to a degree of less than 60%, most preferably less than 20% of its capacity.

In particular, the ion exchanger may be entirely loaded with magnesium.

Information on the loading of the ion exchanger always refers to the delivery status thereof.

As stated in the introductory part, strong softening of the water can therefore be dispensed with.

The determination of the total capacity of the ion exchanger and thus the determination of the degree of loading can be carried out according to DIN 54403:2009-04.

The disclosure also relates to a method for operating a water dispenser, in particular the water dispenser as described above.

The water dispenser comprises a thermoblock, in particular a boiler, for heating the water, and the thermoblock is supplied with carbon dioxide.

The carbon dioxide is preferably supplied from a pressurized gas container which also provides carbon dioxide to a carbonator of the water dispenser.

The supplying of carbon dioxide is preferably effected such that the pH in the thermoblock is adjusted to below 7.5, preferably to between 6.0 and 7.5, most preferably to between 6.5 and 7.0.

Preferably, in this case, the pH value is not measured directly using a measuring device, but rather the dosing of carbon dioxide is accomplished on a time basis and/or on a volume basis, as described above.

By taking into account the local degree of hardness of the water, a controller is able to dose the carbon dioxide such that the aforementioned pH values are maintained.

The thermoblock is preferably heated to at least 60° C., more preferably to at least 80° C., most preferably to the boiling point.

As described above, the dosing of carbon dioxide is preferably achieved using two alternately clocked switching valves, in particular in the form of solenoid valves.

The disclosure furthermore relates to a system for dispensing hot beverages as well as cold carbonated beverages, which comprises the water dispenser as described above and/or which is configured for performing the method described above.

### BRIEF DESCRIPTION OF THE DRAWINGS

The subject-matter of the invention will now be explained in more detail with reference to FIGS. 1 to 4.

FIG. 1 is a schematic diagram of a beverage dispensing system, which comprises a water dispenser.

FIG. 2 shows an alternative embodiment.

FIG. 3 shows a further alternative embodiment.

FIG. 4 is a schematic diagram of an embodiment in which the water dispenser comprises a faucet and a water heater.

### DETAILED DESCRIPTION

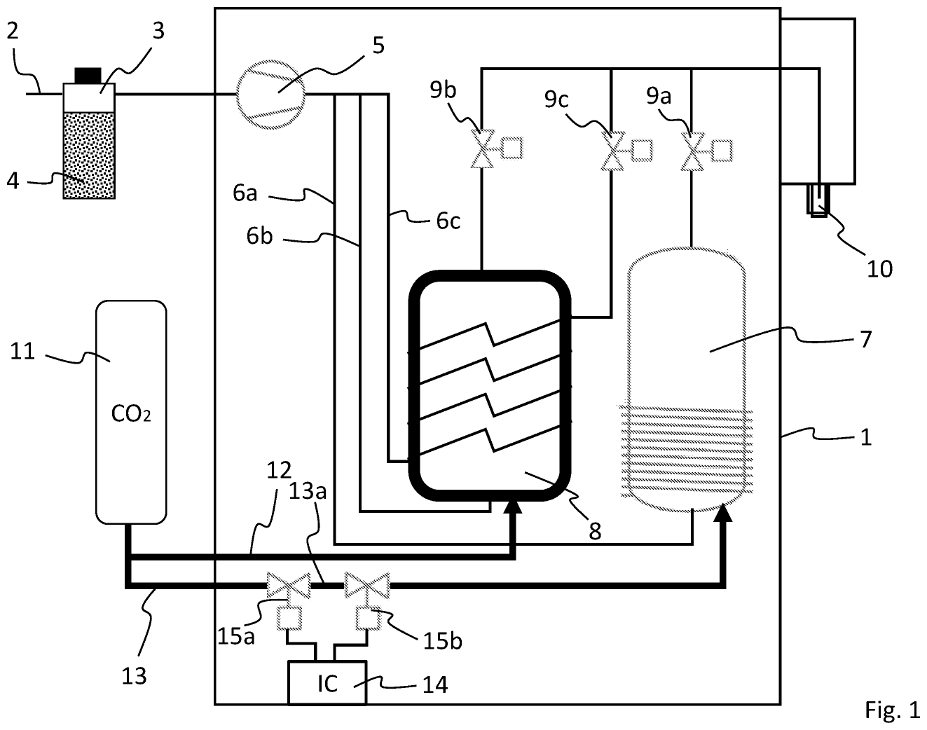

FIG. 1 shows a schematic diagram of a system for dispensing hot beverages and cold carbonated beverages.

This system comprises a water dispenser 1. Water is supplied to the water dispenser 1 via an on-site water pipe 2.

In this embodiment, the water is directed through a water filter which comprises an on-site filter cartridge head 3 that is installed inline in the water pipe 2, and a filter cartridge 4, also known as filter candle, inserted into the filter cartridge head 3.

Inside the filter candle 4, the water may also contain an ion exchanger, for example, which in particular releases magnesium ions into the water to be treated.

The water dispenser 1 comprises a pump 5 which is operable to pump the desired water to an outlet 10.

The water dispenser 1 illustrated here is configured to dispense chilled water, chilled carbonated water, and hot water for preparing hot beverages.

For this purpose, the pipe 2 branches into flow paths 6a to 6c downstream of the pump 5 in this exemplary embodiment.

Flow path 6a is adapted for dispensing hot water. The water is directed through the boiler 7 and from there to the outlet 10.

Delivery of the different types of water is controlled by switching valves 9a to 9c.

That means, in order to deliver hot water, for example, switching valve 9a is opened and the water heated by the boiler 7 will flow to the outlet 10.

Flow path 6b passes through a carbonator 8.

This is a cooled pressure vessel which is connected to a pressurized CO₂ container via line 12.

The water contained in the carbonator 8 is thus pressurized and enriched with a varying amount of carbonic acid (and corresponding dissolved CO₂), depending on the pressure.

Since the pressure in the carbonator 8 can be higher than the applied line pressure, a pump 5 has to be provided at least for the flow path 6b of the carbonator.

When switching valve 9b is opened, chilled carbonated water will be dispensed.

Flow path 6c for water that is only cooled but not enriched with carbonic acid is routed along the cooling coils of the carbonator 8. When switching valve 9c is opened, chilled water will be dispensed.

In order to reduce the formation of scale in the boiler 7, carbonic acid is also fed into the water contained in the boiler 7.

The feeding of carbonic acid is effected using the same pressurized gas container 11 which feeds CO₂ to the carbonator 8.

In this exemplary embodiment, the carbonic acid can be directly supplied to the boiler 7 via line 13.

In order to introduce only a small amount of carbon dioxide, the two switching valves 15a and 15b are connected in series in line 13.

They are alternately controlled by a controller 14.

The line section 13a between switching valves 15a and 15b serves as a pressure accumulator here.

In order to introduce carbon dioxide, first switching valve 15a opens and the line section 13a fills with carbon dioxide.

Then, the first switching valve 15a is closed and switching valve 15b which is downstream thereof is opened by the controller 14.

Now, an amount of carbon dioxide will flow out of line section 13a towards the boiler 7 until pressure equalization is achieved.

This allows to dose even small amounts of carbon dioxide very easily.

The dosing is preferably based on the opening times of switching valve 9a and/or in a time-controlled manner.

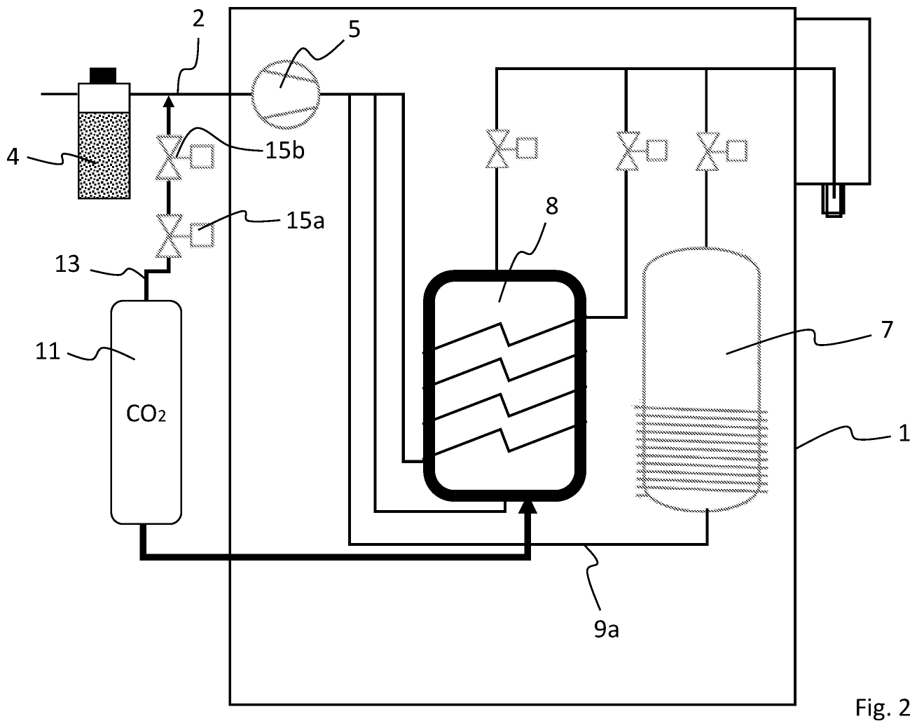

FIG. 2 shows an alternative embodiment of the beverage dispensing system.

As shown here, the carbon dioxide from the pressurized CO₂ gas container 11 does not necessarily have to be fed directly to the boiler 7.

In this exemplary embodiment, the line 13 for feeding carbon dioxide is routed directly to the pipe 2 upstream of pump 5.

Similarly to what is illustrated in FIG. 1, the amount of introduced carbon dioxide is controlled by two switching valves.

In this exemplary embodiment of the beverage dispensing system, the water will already be enriched with a small amount of carbon dioxide when it is fed into the carbonator 8.

The dosing is preferably accomplished inside the water dispenser 1.

For example, dosing may also be effected into line path 6a (not shown).

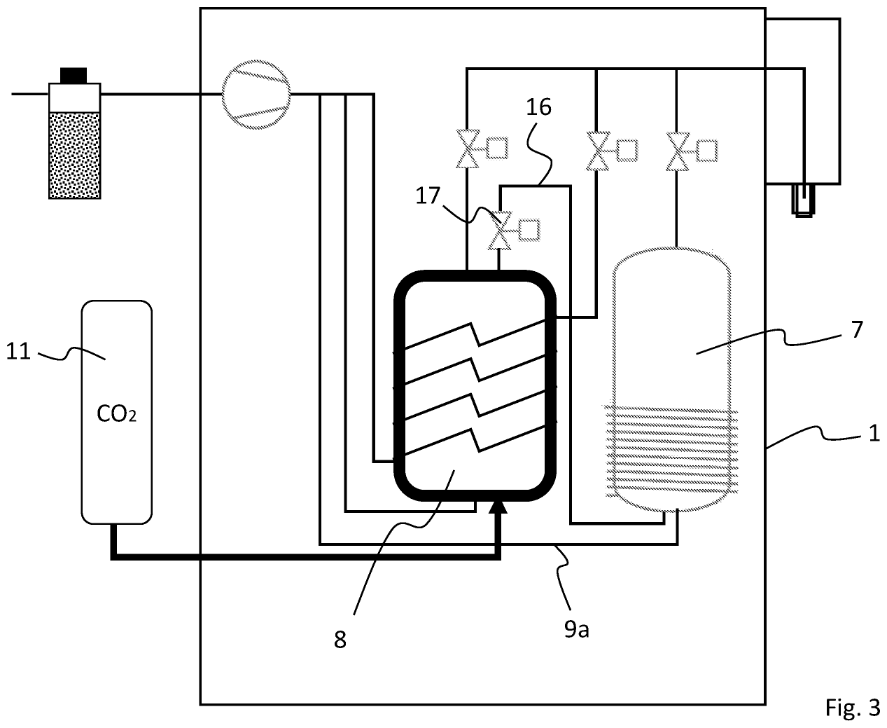

FIG. 3 is a schematic view of a further embodiment of the beverage dispensing system.

According to this embodiment, water from the carbonator 8, which is connected to the pressurized CO₂ gas container 11, is fed into the boiler 7 via line 16.

Hence, the carbon dioxide is not introduced directly, but is dissolved in the water and introduced in the form of carbonic acid.

Due to the larger volume compared to the dosing in gaseous form, a single switching valve 17 can simply be used in this embodiment for effecting the dosing.

A drawback hereof is that water which has been cooled in the carbonator 8 has to be reheated.

According to another embodiment (not shown), it is also possible to provide a separate pressure vessel for introducing carbonated water into the boiler 7.

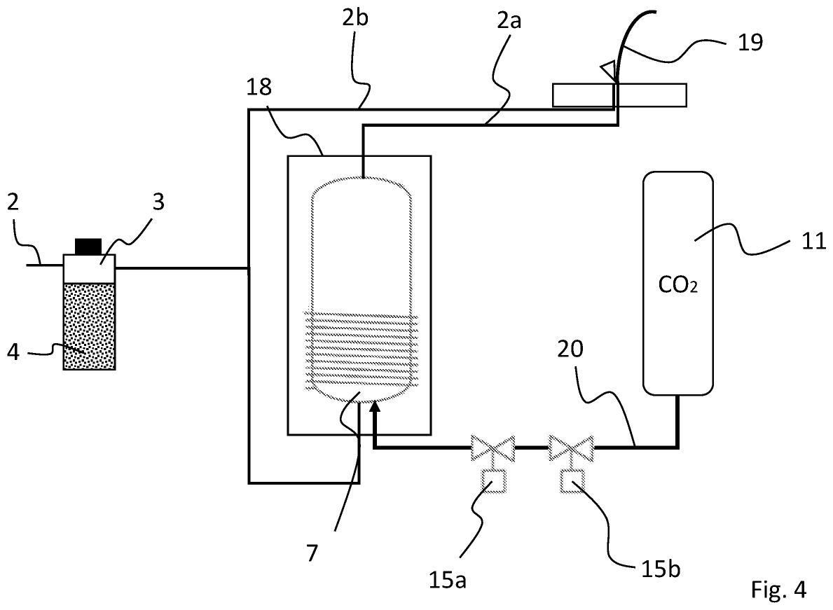

FIG. 4 is a schematic diagram of a water dispenser 1 which comprises a faucet 19 and a water heater 18.

The faucet may come in the form of a mixer tap, for example, as used in the home.

The water directed through the filter candle 4 which includes an ion exchange material branches into two line sections 2a, 2b.

Line section 2b supplies the faucet 19 with cold water.

Line section 2a supplies the faucet 19 with hot water and is routed via the water heater 18.

In this exemplary embodiment, the water heater comprises a boiler 7 and can in particular be designed as an under-sink device.

In order to lower the pH value inside the boiler 7, carbon dioxide is introduced into the boiler 7 via two switching valves 15a, 15b that are arranged in series, similarly to the embodiment of FIG. 1.

Since this results in a reduction of scale formation, the ion exchange material can be loaded with less hydrogen or sodium. The capacity thereby provided in the filter candle 4 can be used for dosing other ions, e.g. magnesium.

If, instead of a filter candle 4, a softening system (not shown) is used which is regenerated using a saline solution, this allows to adjust a higher degree of hardness of the treated water without causing increased scale formation.

In this way, the sodium content of the treated water can be reduced.

The invention made it possible to improve, in a very simple manner, the formation of scale in the thermoblock of a water dispenser, in particular in the water dispenser of a machine for preparing cold and hot beverages.

### LIST OF REFERENCE NUMERALS

1 Water dispenser
2 Water pipe
2a, 2b Pipe section
3 Filter cartridge head
4 Filter cartridge
5 Pump
6a-6c Flow path
7 Boiler
8 Carbonator
9a-9c Switching valve
10 Outlet
11 Pressurized CO₂ gas container
12 Line
13 Line
13a Line section
14 Controller
15a, 15b Switching valve
16 Line
17 Switching valve
18 Water heater
19 Faucet
20 Line

1.-10. (canceled)

11. A water dispenser, comprising:
a heater for dispensing warm water; and
a dosing valve through which carbon dioxide can be introduced into the heater.

12. The water dispenser according to claim 11,
wherein the heater is a boiler and
wherein the dosing valve is a switching valve.

13. The water dispenser according to claim 11, further comprising
a cooled carbonator for dispensing carbonated water, which can be connected to a pressurized carbon dioxide container.

14. The water dispenser according to claim 11,
wherein a partial flow of carbonated water can be fed into the heater,
wherein the partial flow can be mixed with a main flow to the heater, and
wherein the partial flow amounts to between 5% and 50% of a total flow to the heater.

15. The water dispenser according to claim 12, further comprising
a controller which controls the introduction of carbon dioxide via the switching valve on a time basis and/or on a volume basis.

16. The water dispenser according to claim 15,
wherein the introduction of carbon dioxide is adjustable based on a degree of hardness of input water; and/or
wherein the water dispenser comprises two switching valves connected in series, which can be controlled alternately; and/or
wherein water can be fed from the carbonator into the heater; and/or
wherein the heater is connectible to a pressurized carbon dioxide gas container.

17. An assembly, comprising:
the water dispenser as claimed in claim 11; and
a cartridge for water treatment, through which water is supplied to the water dispenser,
wherein the cartridge is configured for releasing magnesium, silicon, lithium, and/or zinc into the water.

18. The assembly according to claim 17,
wherein the cartridge contains an ion exchange material loaded with magnesium and/or zinc;
wherein the ion exchange material is loaded with magnesium or zinc to a degree of at least 50% of its total capacity; and/or
wherein the ion exchange material is loaded with hydrogen and/or sodium to a degree of less than 20% of its total capacity.

19. A method for operating a water dispenser that comprises a heater for heating water, the method comprising:
supplying carbon dioxide to the heater.

20. The method according to claim 19,
wherein the supplying of carbon dioxide is effected so as to adjust the pH in the heater to between 6.5 and 7.0.

21. The method according to claim 19,
wherein the water in the heater is heated to at least 80° C.; and/or
wherein the supplying of carbon dioxide is effected via two solenoid valves, which are clocked alternately.
